(19) United States
(12) Patent Application Publication
(10) Pub. No.: US 2017/0033374 A1
(43) Pub. Date: Feb. 2, 2017

(54) COATING METHOD OF SEPERATOR FOR FUEL CELL AND SEPERATOR FOR FUEL CELL

(71) Applicant: HYUNDAI MOTOR COMPANY, Seoul (KR)

(72) Inventors: Kwang Hoon CHOI, Yongin-si (KR); Woong Pyo HONG, Seoul (KR); Jiyoun SEO, Suwon-si (KR); Hyun Dal PARK, Suwon-si (KR); Bokyung KIM, Yongin-si (KR); Jungyeon PARK, Yongin-si (KR); In Woong LYO, Suwon-si (KR)

(21) Appl. No.: 14/954,379

(22) Filed: Nov. 30, 2015

(30) Foreign Application Priority Data
Jul. 27, 2015 (KR) 10-2015-0106104

(51) Int. Cl. H01M 8/0245; H01M 8/0236; H01M 8/0234

(52) U.S. Cl. CPC H01M 8/0245; H01M 8/0234; H01M 8/0236; H01M 2250/20

(57) ABSTRACT

A coating method of a separator for a fuel cell includes steps of vaporizing a precursor to prepare a precursor gas; introducing the precursor gas and a reactive gas into a reaction chamber; and forming a coating layer on a base material by applying a voltage to the reaction chamber to change the precursor gas and the reactive gas into a plasma state.

### CROSS-REFERENCE TO RELATED APPLICATION

This application claims the benefit of priority to Korean Patent Application No. 10-2015-0106104, filed in the Korean Intellectual Property Office on Jul. 27, 2015, the entirety of which is incorporated herein by reference.

### TECHNICAL FIELD

The present disclosure relates to a coating method of a separator for a fuel cell and a separator for a fuel cell.

### BACKGROUND

A fuel cell stack may include an assembly device that assembles repeatedly stacked components such as an electrode membrane, a separator, a gas diffusion layer, and a gasket with a stack module, along with an encloser protecting the stack, non-repetitive components such as components required for an interface with a vehicle, a high-voltage connector, and the like. The fuel cell stack is an apparatus in which hydrogen and oxygen in the air react with each other to release electricity, water, and heat, but since high voltage electricity, water, and hydrogen coexist in the same place, there are many risk factors in the fuel cell stack.

In particular, regarding a separator for a fuel cell, since hydrogen cations generated at the time of driving a fuel cell directly contact the separator for a fuel cell, corrosion resistance is further required, and in the case of applying a metal separator without surface-treatment, the metal may be corroded, and an oxide may be formed on the metal surface that acts as an electrical insulator, thereby decreasing electrical conductivity. In this case, metal cations that are dissociated to thereby be eluted contaminate a membrane electrode assembly (MEA), thereby deteriorating the performance of the fuel cell.

In the case of a carbon-based separator currently used as the separator for a fuel cell, there is a high risk that cracks generated in a process will remain in the fuel cell, it is difficult to thin the separator in view of strength and gas permeability, and there is a problem in processability, or the like.

Meanwhile, the metal separator may be advantageous in view of formability and productivity due to excellent flexibility. In addition, it may be thinned, such that the stack may be miniaturized. Performance of the stack may be deteriorated, however, due to contamination of the MEA caused by corrosion and an increase in contact resistance caused by formation of a surface oxide layer. Therefore, a surface treatment method capable of suppressing surface corrosion and oxide layer growth has been required.

The above information disclosed in this Background section is only for enhancement of understanding of the background of the inventive concept and therefore it may contain information that does not form the prior art that is already known in this country to a person of ordinary skill in the art.

### SUMMARY

The present disclosure has been made in an effort to provide a coating method of a separator for a fuel cell.

In addition, the present disclosure has been made in an effort to provide a separator for a fuel cell.

The present disclosure has also been made in an effort to provide a precursor for a separator for a fuel cell.

An exemplary embodiment of the present inventive concept provides a coating method of a separator for a fuel cell including steps of: vaporizing a precursor to prepare a precursor gas; introducing the precursor gas and a reactive gas into a reaction chamber; and forming a coating layer on a base material by applying a voltage to the reaction chamber to change the precursor gas and the reactive gas into a plasma state. The precursor may contain a compound represented by Chemical Formula 1:

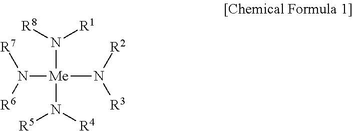

where R¹ to R⁸ are each independently a substituted or unsubstituted C1 to C10 alkyl group, N is nitrogen, and Me is Ti, Cr, Mo, W, Cu, or Nb. In addition, the precursor may further contain a compound represented by Chemical Formula 2, where the compound represented by Chemical Formula 1 and the compound represented by Chemical Formula 2 are different from each other:

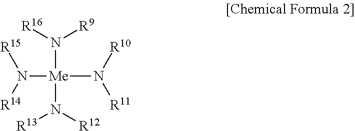

where R⁹ to R¹⁶ are each independently a substituted or unsubstituted C1 to C10 alkyl group, N is nitrogen, and Me is Ti, Cr, Mo, W, Cu, or Nb.

All of R⁹ to R¹⁶ may be methyl (CH₃) groups.

The forming of the coating layer on the base material may be performed in a temperature range of 200° C. or less.

The vaporizing of the precursor to prepare the precursor gas may be performed in a temperature range of 50 to 80° C.

The reactive gas may include a hydrocarbon gas; an inert gas; and a nitrogen compound gas or nitrogen gas.

The hydrocarbon gas may be a material selected from C₂H₂, CH₄, and a combination thereof, the inert gas may be Ar, and the nitrogen compound may be NH₃.

In addition, the coating method may further include, after the forming of the coating layer on the base material by changing the precursor gas and the reactive gas into the plasma state, imparting a hydrophobic or hydrophilic group.

The imparting of the hydrophobic or hydrophilic group may be changing a gas selected from the group consisting of CF₄, O₂, CO₂, polydimethylsiloxane (PDMS), trimethylsilyl (TMS), and combination thereof into a plasma state to react F, O, Si, or a combination thereof with a surface of the coating layer.

Another embodiment of the present inventive concept provides a separator for a fuel cell including: a separator for a fuel cell; and a coating layer positioned on one surface or both surfaces of the separator for a fuel cell, wherein the coating layer contains carbon having a SP² structure; and a nitride of a material selected from Ti, Cr, Mo, W, Cu, Nb, and a combination thereof.

In the coating layer, a content range of carbon having the SP² structure may be 40% to 70%, and the remainder may be the nitride of the material selected from Ti, Cr, Mo, W, Cu, Nb, and the combination thereof.

The coating layer may have a thickness of 20 nm to 1000 nm. The coating layer may further contain a material selected from F, O, Si, and a combination thereof.

Yet another embodiment of the present inventive concept provides a precursor for a separator for a fuel cell containing a compound represented by Chemical Formula 1.

The precursor may further contain a compound represented by Chemical Formula 2, and the compound represented by Chemical Formula 1 and the compound represented by Chemical Formula 2 may be different from each other.

According to an embodiment of the present inventive concept, the coating layer may be formed at a low temperature, such that deformation of the base material may be minimized.

According to an embodiment of the present inventive concept, the coating layer may be formed at a low temperature, such that a manufacturing cost may be decreased.

According to an embodiment of the present inventive concept, the coating layer may be formed by a plasma enhanced chemical vapor deposition (PECVD) process, such that even in a case of a large area coating layer or mass production of the coating layer, the coating layer may be formed.

### BRIEF DESCRIPTION OF THE DRAWINGS

FIG. 1 is a mimetic view illustrating a plasma enhanced chemical vapor deposition (PECVD) device for forming a coating layer on a separator for a fuel cell according to an exemplary embodiment of the present inventive concept.

FIG. 2 is a graph illustrating contact resistance and corrosion current depending on the temperature of a reaction chamber in the Examples.

FIGS. 3A-3D are photographs illustrating a surface of a coated separator depending on each deposition temperature.

FIGS. 4A and 4B are schematic views illustrating a measuring method of contact resistance of a separator-separator.

FIGS. 5A and 5B are schematic views illustrating a measuring method of contact resistance of a gas diffusion layer (GDL)-separator.

### DETAILED DESCRIPTION OF THE EMBODIMENTS

Advantages and features of the present inventive concept and methods to achieve them will be elucidated from exemplary embodiments described below in detail with reference to the accompanying drawings. However, the present inventive concept is not limited to the exemplary embodiment disclosed herein but will be implemented in various forms. The exemplary embodiments make disclosure of the present inventive concept thorough and are provided so that those skilled in the art can easily understand the scope of the present inventive concept. Therefore, the present inventive concept will be defined by the scope of the appended claims. Like reference numerals throughout the specification denote like elements.

Therefore, in order to avoid obscure interpretation of the present inventive concept, a detailed description of technologies well known in the art will be omitted in exemplary embodiments. Unless otherwise defined, all terms (including technical terms and scientific terms) used in the present specification may be used as the general meaning commonly understood by those skilled in the art to which the present inventive concept pertains. Throughout the present specification, unless explicitly described to the contrary, the word “comprise” and variations such as “comprises” or “comprising” will be understood to imply the inclusion of stated elements but not the exclusion of any other elements. Unless explicitly described to the contrary, a singular form includes a plural form in the present specification.

As used herein, unless otherwise defined, the term “substituted” means that a compound substituted with a C1 to C30 alkyl group; a C1 to C10 alkylsilyl group; a C3 to C30 cycloalkyl group; a C6 to C30 aryl group; a C2 to C30 heteroaryl group; a C1 to C10 alkoxy group; a fluoro group or a C1 to C10 trifluoroalkyl group such as a trifluoromethyl group, or the like; or a cyano group.

As used herein, unless otherwise defined, the term “combination thereof” means that two or more substituents are bonded to each other by a linker or two or more substituents are condensed and bonded to each other.

As used herein, unless otherwise defined, the term “alkyl group” includes both a “saturated alkyl group” that does not include any alkene group or alkyne group and an “unsaturated alkyl group” including at least one alkene group or alkyne group. The “alkene group” refers to a substituent of at least one carbon-carbon double bond of at least two carbon atoms, and the “alkyne group” refers to a substituent of at least one carbon-carbon triple bond of at least two carbon atoms. The alkyl group may be a branched, linear, or cyclic alkyl group.

The alkyl group may be a C1 to C20 alkyl group, more specifically, a C1 to C6 lower alkyl group, a C7 to C10 medium alkyl group, or a C11 to C20 higher alkyl group.

For example, the C1 to C4 alkyl group means that 1 to 4 carbon atoms exist in an alkyl chain, and the C1 to C4 alkyl group may be selected from the group consisting of methyl, ethyl, propyl, isopropyl, n-butyl, isobutyl, sec-butyl, and t-butyl.

Typical examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

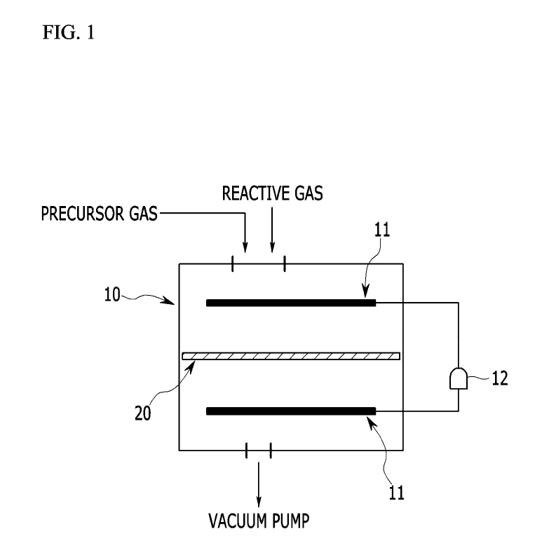

FIG. 1 is a mimetic view illustrating a plasma enhanced chemical vapor deposition (PECVD) device for forming a coating layer on a separator for a fuel cell according to an exemplary embodiment of the present inventive concept.

Referring to FIG. 1, the PECVD device used in the exemplary embodiment of the present inventive concept includes a reaction chamber 10 in which a vacuum state is maintained and plasma may be formed, and a gas supply device supplying a reactive gas, a precursor gas, or the like, into the reaction chamber.

In addition, a vacuum pump for forming vacuum in the chamber is connected to the reaction chamber 10, and a base material (separator) is positioned between electrodes 11 installed in the reaction chamber 10. When power is supplied from the power supply device 12, gases in the reaction chamber are changed into a plasma state. The gases in the plasma state are polymerized to thereby be coated on a surface of the base material 20.

First, the precursor gas is prepared by vaporizing a precursor.

The precursor may contain a compound represented by the following Chemical Formula 1:

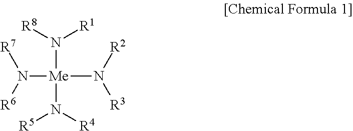

where R¹ to R⁸ are each independently a substituted or unsubstituted C1 to C10 alkyl group, N is nitrogen, and Me is Ti, Cr, Mo, W, Cu, or Nb.

In addition, the precursor may further contain a compound represented by the following Chemical Formula 2, and the compound represented by Chemical Formula 1 and the compound represented by Chemical Formula 2 may be different from each other:

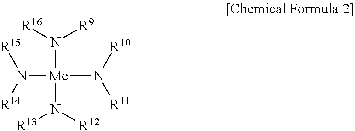

where R⁹ to R¹⁶ are each independently a substituted or unsubstituted C1 to C10 alkyl group, N is nitrogen, and Me is Ti, Cr, Mo, W, Cu, or Nb.

All of R¹ to R⁸ may be methyl (CH₃) groups.

The precursor may be vaporized at 50° C. or more. When a temperature of the precursor is more than 80° C., characteristics of the precursor may be changed by heat.

The precursor gas and the reactive gas are introduced into the reaction chamber.

The reactive gas may include a hydrocarbon gas; an inert gas; and a nitrogen compound gas or nitrogen gas.

The hydrocarbon gas may be a material selected from C₂H₂, CH₄, and a combination thereof, the inert gas may be Ar, and the nitrogen compound may be NH₃.

When the precursor gas and the reactive gas are introduced into the reaction chamber, the precursor gas and the reactive gas are changed into the plasma state by applying a voltage to the reaction chamber. The gases changed into the plasma state are deposited on the surface of the base material to thereby be polymerized and coated thereon.

In this case, the forming of the coating layer on the base material may be performed in a temperature range of 200° C. or less. In the case in which deposition is performed at a temperature higher than 200° C., contact resistance and corrosion current may be increased.

In the forming of the coating layer on the base material, a lower limit of the temperature range is not particularly limited. However, in the case in which deposition is performed at a temperature lower than 100° C., the vaporized precursor may be condensed, or the precursor may be incompletely decomposed, such that contact resistance may be increased.

Further, in the forming of the coating layer on the base material, the pressure of the reaction chamber may be 0.01 to 10 Torr.

When the pressure of the reaction chamber is less than 0.01 Torr, an amount of decomposed ions is small, such that a deposition rate may be decreased, and when the pressure is more than 10 Torr, adhesion may be deteriorated.

Further, a coating method of a separator for a fuel cell according to an exemplary embodiment in the present inventive concept may further include, after the forming of the coating layer on the base material by changing the precursor gas and the reactive gas into the plasma state, imparting a hydrophobic or hydrophilic group.

The imparting of the hydrophobic or hydrophilic group may be changing gas selected from the group consisting of CF₄, O₂, CO₂, polydimethylsiloxane (PDMS), trimethylsilyl (TMS), and combination thereof into a plasma state to react F, O, Si, or a combination thereof with a surface of the coating layer.

A separator for a fuel cell according to an exemplary embodiment of the present inventive concept may include: a separator for a fuel cell; and a coating layer positioned on one surface or both surfaces of the separator for a fuel cell, wherein the coating layer contains carbon having a SP² structure; and a nitride of a material selected from Ti, Cr, Mo, W, Cu, Nb, and a combination thereof. The SP² structure is a structure in which one carbon is bonded to three adjacent atoms present in the same plane.

Here, a content of carbon having the SP² structure based on 100 at % of the entire coating layer may be 40 to 70 at %. More specifically, the content of carbon having the SP² structure may be 50 to 70 at %. Further, in the case in which a Ti nitride is contained in the coating layer, a content of Ti present in the coating layer may be 30 at % or more.

In addition, the coating layer may have a thickness of 20 nm to 1 mm. More specifically, the coating layer may have a thickness of 1 μm or less.

When the thickness of the coating layer is less than 20 nm, corrosion resistance may be deteriorated. In addition, when the thickness is more than 1 mm, more specifically, 1 μm, conductivity may be deteriorated.

Further, the coating layer may further contain a material selected from F, O, Si, and a combination thereof.

Hereinafter, the present inventive concept will be described in detail with reference to illustrative Examples. However, the following Examples are only to exemplify the present inventive concept, and contents of the present inventive concept are not limited by the following Examples.

### Example

A precursor gas was prepared by heating and vaporizing a precursor containing a compound represented by the following Chemical Formula 3 at 50° C.:

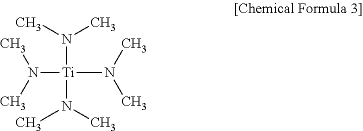

Thereafter, the precursor gas, C₂H₂, NH₃, and Ar were introduced into a reaction chamber.

Then, the gases were changed into a plasma state by applying a voltage to the reaction chamber, and deposited on a base material. As the base material, SUS316L defined by JIS standard was used. Contact resistance and corrosion current at 0.6 V were measured by performing a test while changing a temperature condition of the reaction chamber at the time of forming a coating layer. A pressure of the reaction chamber was 0.8 Torr, and PF power of 1500 W was applied.

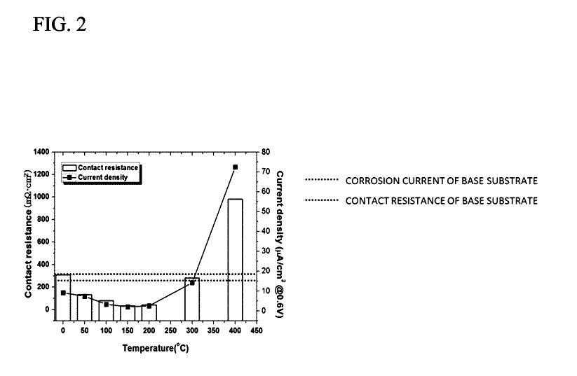

Test results were illustrated in FIG. 2 and Table 1.

TABLE 1

| Deposition | Contact | Corrosion |
|---|---|---|
| temperature | resistance | current |
| (° C.) | (mΩ · cm²) | (μA/cm²) |
| 0 | 308.4 | 9.2 |
| 50 | 132.3 | 7.4 |
| 100 | 79.9 | 3.4 |
| 150 | 34.8 | 2.1 |
| 200 | 41.7 | 2.6 |
| 300 | 280.1 | 14.2 |
| 400 | 981.3 | 72.4 |

A measuring method of contact resistance was as follows.

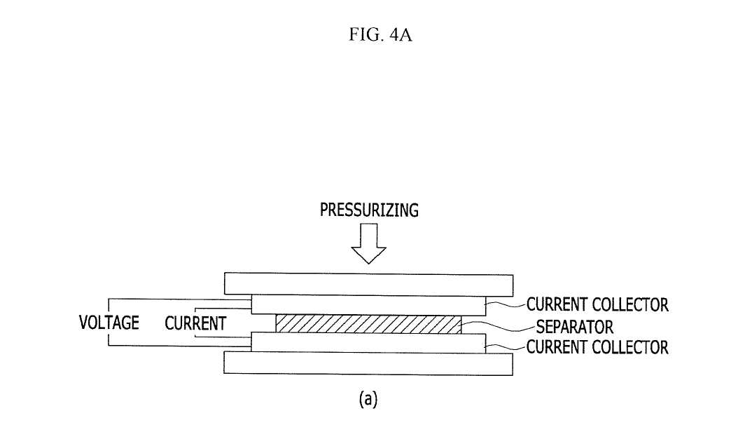

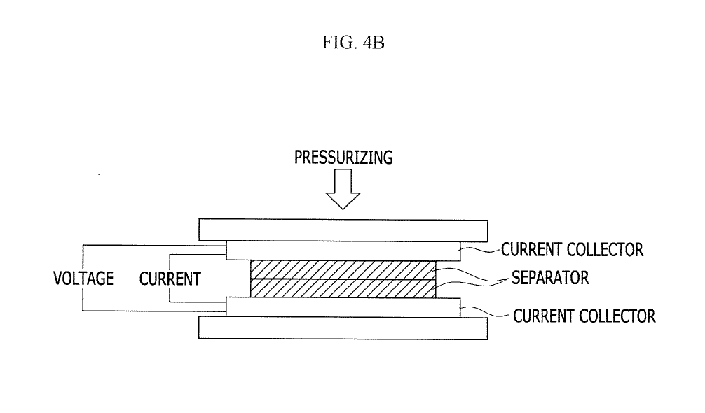

FIGS. 4A and 4B are schematic views illustrating the measuring method of contact resistance of a separator-separator.

First, as illustrated in FIG. 4A, one separator was disposed between current collectors plated with Au, and a pressure of 10 kgf/cm² was applied, thereby measuring resistance (R1, mΩ). Thereafter, as illustrated in FIG. 4B, two separators were disposed between the current collectors, and resistance (R2, mΩ) was measured under the same conditions.

Contact resistance (mΩ·cm²) of the separator-separator was calculated as (R2−R1)*an area of the separator.

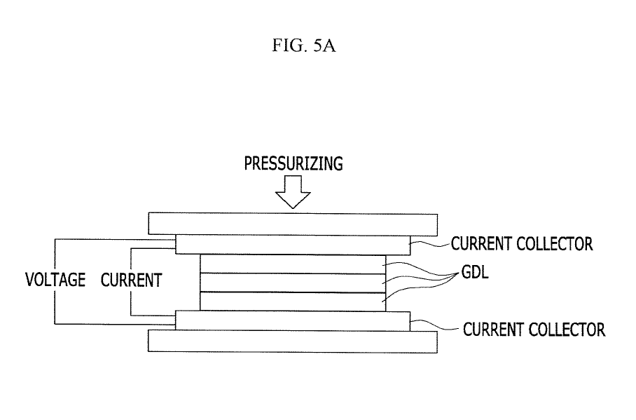

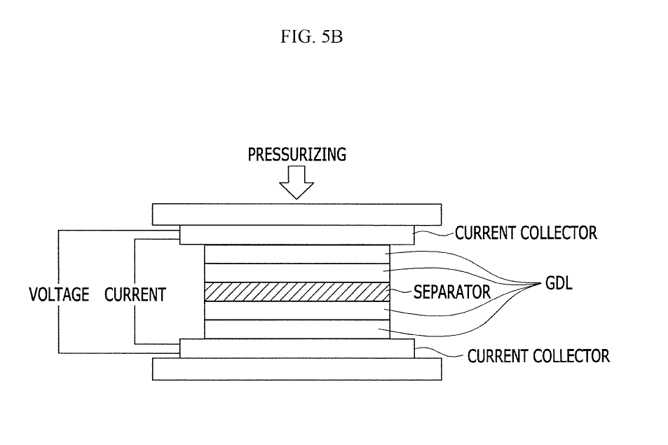

FIGS. 5A and 5B are schematic views illustrating a measuring method of contact resistance of a gas diffusion layer (GDL)-separator.

First, as illustrated in FIG. 5A, three gas diffusion layers (GDLs) were disposed between current collectors plated with Au, and a pressure of 10 kgf/cm² was applied, thereby measuring resistance (R3, mΩ). As the gas diffusion layer (GDL), 10BB (SGL Inc.) formed of a porous carbon material was used.

Thereafter, as illustrated in FIG. 5B, four gas diffusion layers (GDLs) were disposed between the current collectors, one separator was disposed in the middle of the gas diffusion layers (GDLs), and resistance (R4, mΩ) was measured under the same conditions.

Contact resistance (mΩ·cm²) of the GDL-separator was calculated as (R4−R3)*an area of the separator.

Then, a sum of contact resistance of the separator-separator and contact resistance of the GDL-separator was calculated as contact resistance.

Referring to Table 1 and FIG. 2, in the case in which deposition was performed at a temperature higher than 200° C., contact resistance and corrosion current were increased, and there was a possibility that a coating layer will be delaminated by internal residual stress of a carbon-based coating material. Further, in the case in which deposition was performed at a temperature lower than 100° C., contact resistance and corrosion current were increased as compared to the case in which deposition was performed at a temperature of 100° C. or more.

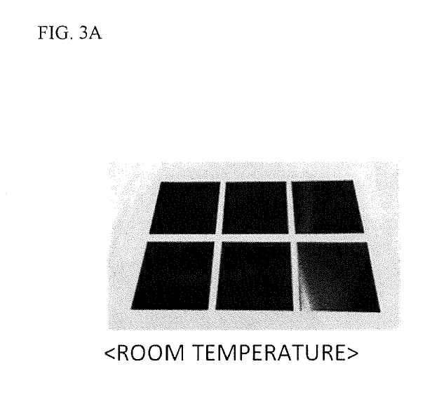

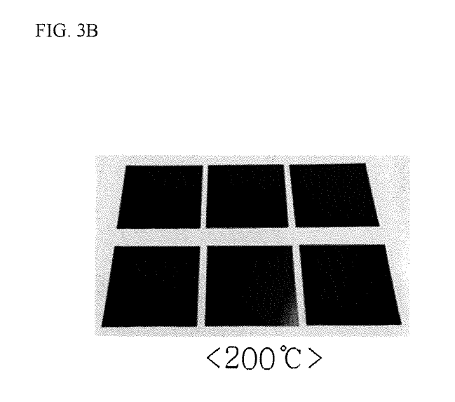

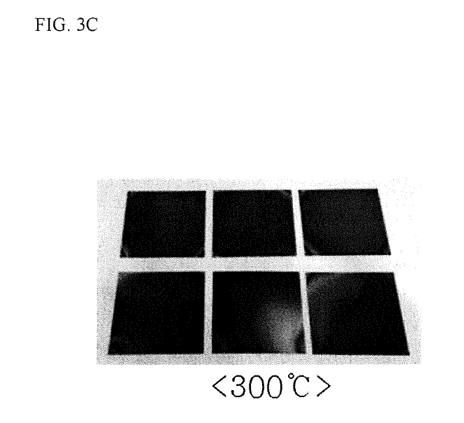

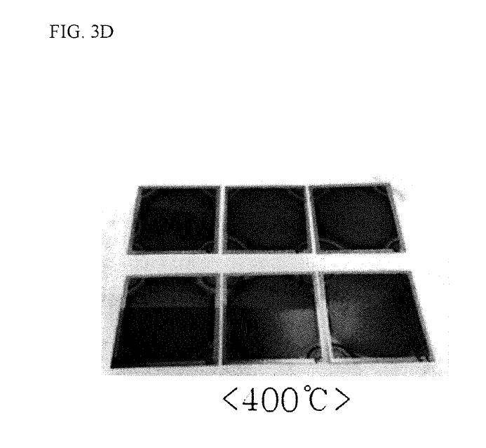

FIGS. 3A-3D are photographs illustrating a surface of a coated separator depending on each deposition temperature. Referring to FIGS. 3A-3D, it may be appreciated that when deposition was performed at 200° C. or less, a uniform coating layer was formed.

Although the exemplary embodiments of the present inventive concept have been described with reference to the accompanying drawings, those skilled in the art to which the present inventive concept pertains will appreciate that various modifications and alterations may be made without departing from the spirit or essential feature of the present inventive concept.

Therefore, it should be understood that the above-mentioned embodiments are not restrictive but are exemplary in all aspects. It should be interpreted that the scope of the present inventive concept is defined by the following claims rather than the above-mentioned detailed description and all modifications or alterations deduced from the meaning, the scope, and equivalences of the claims are included in the scope of the present inventive concept.

What is claimed is:

1. A coating method of a separator for a fuel cell, the coating method comprising steps of:
vaporizing a precursor containing a compound represented by Chemical Formula 1 to prepare a precursor gas;
introducing the precursor gas and a reactive gas into a reaction chamber; and
forming a coating layer on a base material by applying a voltage to the reaction chamber to change the precursor gas and the reactive gas into a plasma state: 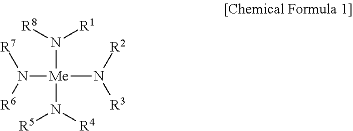
where R¹ to R⁸ are each independently a substituted or unsubstituted C1 to C10 alkyl group,
N is nitrogen, and
Me is Ti, Cr, Mo, W, Cu, or Nb.

2. The coating method of claim 1, wherein:
the precursor further contains a compound represented by Chemical Formula 2, and
the compound represented by Chemical Formula 1 and the compound represented by Chemical Formula 2 are different from each other: 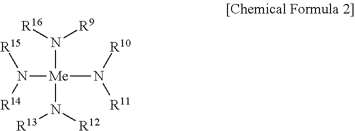
where R⁹ to R¹⁶ are each independently a substituted or unsubstituted C1 to C10 alkyl group,
N is nitrogen, and
Me is Ti, Cr, Mo, W, Cu, or Nb.

3. The coating method of claim 1, wherein:
all of R¹ to R⁸ are methyl (CH₃) groups.

4. The coating method of claim 1, wherein:
the step of forming the coating layer on the base material is performed in a temperature range of 200° C. or less.

5. The coating method of claim 4, wherein:
the step of vaporizing the precursor to prepare the precursor gas is performed in a temperature range of 50 to 80° C.

6. The coating method of claim 5, wherein:
the reactive gas includes a hydrocarbon gas; an inert gas; and a nitrogen compound gas or nitrogen gas.

7. The coating method of claim 6, wherein:
the hydrocarbon gas is a material selected from the group consisting of C₂H₂, CH₄, and a combination thereof,
the inert gas is Ar, and
the nitrogen compound is NH₃.

8. The coating method of claim 1, further comprising,
after the step of forming the coating layer on the base material by changing the precursor gas and the reactive gas into the plasma state, imparting a hydrophobic or hydrophilic group.

9. The coating method of claim 8, wherein:
the imparting of the hydrophobic or hydrophilic group includes changing a gas selected from the group consisting of CF₄, O₂, CO₂, polydimethylsiloxane (PDMS), trimethylsilyl (TMS), and a combination thereof into a plasma state to react F, O, Si, or a combination thereof with a surface of the coating layer.

10. A separator for a fuel cell comprising:
a separator; and
a coating layer disposed on at least one surface of the separator,
wherein the coating layer contains carbon having an SP² structure, and
a nitride of a material selected from the group consisting of Ti, Cr, Mo, W, Cu, Nb, and combinations thereof.

11. The separator for a fuel cell of claim 10, wherein:
in the coating layer, a content range of carbon having the SP² structure is 40% to 70% of the total content of the coating layer, and the remainder of the content of the coating layer is the nitride of the material selected from the group consisting of Ti, Cr, Mo, W, Cu, Nb, and the combination thereof.

12. The separator for a fuel cell of claim 10, wherein:
the coating layer has a thickness of 20 nm to 1000 nm.

13. The separator for a fuel cell of claim 12, wherein:
the coating layer further contains a material selected from F, O, Si, and combinations thereof.

14. A precursor for a separator for a fuel cell, the precursor comprising a compound represented by Chemical Formula 1: 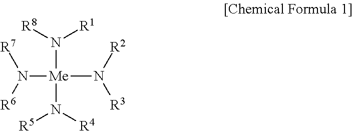
where R¹ to R⁸ are each independently a substituted or unsubstituted C1 to C10 alkyl group,
N is nitrogen, and
Me is Ti, Cr, Mo, W, Cu, or Nb.

15. The precursor of claim 14, further comprising
a compound represented by Chemical Formula 2,
wherein the compound represented by Chemical Formula 1 and the compound represented by Chemical Formula 2 are different from each other: 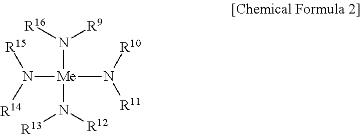
where R⁹ to R¹⁶ are each independently a substituted or unsubstituted C1 to C10 alkyl group,
N is nitrogen, and
Me is Ti, Cr, Mo, W, Cu, or Nb.

16. The precursor of claim 14, wherein:
all of R¹ to R⁸ are methyl (CH₃) groups.
